(19) United States
(12) Patent Application Publication
(10) Pub. No.: US 2025/0188257 A1
(43) Pub. Date: Jun. 12, 2025

(54) RESIN COMPOSITION AND METHOD FOR MANUFACTURING THE SAME, AND PLASTIC FLOOR TILE STRUCTURE

(71) Applicant: NAN YA PLASTICS CORPORATION, TAIPEI (TW)

(72) Inventors: TE-CHAO LIAO, TAIPEI (TW); HAO-SHENG CHEN, TAIPEI (TW); CHUN-LAI CHEN, TAIPEI (TW)

(21) Appl. No.: 18/433,338

(22) Filed: Feb. 5, 2024

(30) Foreign Application Priority Data
Dec. 11, 2023 (TW) 112148038

(51) Int. Cl. C08L 27/06; B32B 27/08; B32B 27/20; B32B 27/22; B32B 27/30; C08K 3/105; E04F 15/10

(52) U.S. Cl. CPC C08L 27/06; B32B 27/08; B32B 27/20; B32B 27/22; B32B 27/304; C08K 3/105; E04F 15/105; E04F 15/107; B32B 2250/03; B32B 2250/24; B32B 2264/1021; B32B 2264/1022; B32B 2264/1023; B32B 2264/303; B32B 2307/4026; B32B 2307/54; B32B 2307/5825; B32B 2307/75; B32B 2419/04

(57) ABSTRACT

A resin composition and a method for manufacturing the same, and a plastic floor tile structure are provided. The resin composition is used to form a middle layer of a plastic floor tile structure. The resin composition includes 100 phr of a polyvinyl chloride resin, 0.1 phr to 5 phr of a plasticizer, 4 phr to 15 phr of a heat stabilizer composition, 0.5 phr to 3 phr of an accelerant, 1 phr to 5 phr of a toughener, 0.1 phr to 0.5 phr of a lubricant composition, 0.1 phr to 1 phr of an antioxidant, and 0.1 phr to 20 phr of a composite pigment. The heat stabilizer composition includes a calcium-zinc stabilizer and an auxiliary stabilizer. The accelerant is a copolymer polymerized from a vinyl chloride monomer and a polyester monomer. The composite pigment includes a core layer and a shell layer encapsulating the core layer.

### CROSS-REFERENCE TO RELATED PATENT APPLICATION

This application claims the benefit of priority to Taiwan Patent Application No. 112148038, filed on Dec. 11, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a resin composition and a method for manufacturing the same, and a plastic floor tile structure and more particularly to a resin composition and a method for manufacturing the same, and an environmentally friendly plastic floor tile structure.

### BACKGROUND OF THE DISCLOSURE

Plastic floor tiles have become quite popular as a decorative material for the floor in recent years. Plastic floor tiles have been widely used in various locations, such as in houses, hospitals, office buildings, factories, gymnasiums, and other places. Compared to a traditional floor tile, the plastic floor tile can be manufactured through mass production, and also have the advantage of being light-weight. Therefore, the plastic floor tile is convenient for transportation, installation, and usage.

Tin stabilizers or zinc stabilizers are usually contained in the plastic floor tile so as to enhance their heat resistance. However, the tin stabilizers and the zinc stabilizers all contain phenolics such as bisphenol A, renohol, or phenol. These phenolics are not only environmentally unfriendly but may also cause damage to the human body. Therefore, with consideration for environmental protection or safety, the usage of the toxic phenolics should be prevented.

Some environmentally friendly stabilizers, such as: calcium zinc stabilizer or water talc stabilizer are currently available on the market. However, the addition of the calcium zinc stabilizers or the water talc stabilizers will reduce the plasticization rate, thereby decreasing productivity of a resin composition. If the resin composition is incompletely plasticized, a printability of the plastic floor tile will be negatively affected. In addition, after a long period of use, molecular plastic may emerge from a surface of the plastic floor tile or white stripes may be formed on the surface of the plastic floor tile.

Therefore, how to improve the properties of the resin composition of the plastic floor tile by adjusting the components has become one of the important issues to be solved in the industry.

### SUMMARY OF THE DISCLOSURE

In response to the above-referenced technical inadequacy, the present disclosure provides a resin composition and a method for manufacturing the same, and a plastic floor tile structure.

In order to solve the above-mentioned problems, one of the technical aspects adopted by the present disclosure is to provide a resin composition. The resin composition is used to form a middle layer of a plastic floor tile structure. The resin composition includes 100 phr of a polyvinyl chloride resin, 0.1 phr to 5 phr of a plasticizer, 4 phr to 15 phr of a heat stabilizer composition, 0.5 phr to 3 phr of an accelerant, 1 phr to 5 phr of a toughener, 0.1 phr to 0.5 phr of a lubricant composition, 0.1 phr to 1 phr of an antioxidant, and 0.1 phr to 20 phr of a composite pigment. The heat stabilizer composition includes a calcium-zinc stabilizer and an auxiliary stabilizer. The accelerant is a copolymer polymerized from a vinyl chloride monomer and a polyester monomer. The composite pigment includes a core layer and a shell layer encapsulating the core layer.

In one of the possible or preferred embodiments, a size of the composite pigment ranges from 1 μm to 5 μm.

In one of the possible or preferred embodiments, the shell layer of the composite pigment is surface modified with aluminum oxide or silicon dioxide.

In one of the possible or preferred embodiments, the shell layer is titanium dioxide.

In one of the possible or preferred embodiments, a degree of polymerization of the polyvinyl chloride resin ranges from 700 to 1000.

In one of the possible or preferred embodiments, relative to 100 phr of the polyvinyl chloride resin, an amount of the calcium-zinc stabilizer ranges from 3 phr to 10 phr, and the auxiliary stabilizer ranges from 1 phr to 5 phr.

In one of the possible or preferred embodiments, the auxiliary stabilizer is selected from the group consisting of epoxidized soybean oil, dibenzoylmethane, and stearoylbenzoylmethane.

In one of the possible or preferred embodiments, based on a total weight of the vinyl chloride monomer and the polyester monomer to polymerize the accelerant being 100 wt %, an amount of the vinyl chloride monomer ranges from 65 wt % to 85 wt %.

In one of the possible or preferred embodiments, the accelerant is modified by a functional group selected from the group consisting of a vinyl group, a vinylidene chloride group, a vinyl acetate group, a vinyl neodecanoate group, and an acrylate group.

In one of the possible or preferred embodiments, the accelerant is modified by a vinylidene chloride group and an acrylate group.

In one of the possible or preferred embodiments, based on a total weight of the accelerant being 100 wt %, the accelerant is modified by 10 wt % to 15 wt % of a vinyl group or a vinylidene chloride group.

In one of the possible or preferred embodiments, based on a total weight of the accelerant being 100 wt %, the accelerant is modified by 5 wt % to 15 wt % of a vinyl acetate group, a vinyl neodecanoate group, or an acrylate group.

In one of the possible or preferred embodiments, the composite lubricant includes an internal lubricant and an external lubricant, and a weight ratio of the internal lubricant to the external lubricant ranges from 3:7 to 7:3.

In one of the possible or preferred embodiments, the internal lubricant is selected from the group consisting of a fatty alcohol, a fatty acid ester, and a fatty acid amide.

In order to solve the above-mentioned problems, another one of the technical aspects adopted by the present disclosure is to provide a method for manufacturing the resin composition. The method for manufacturing the plastic floor tile structure includes steps of: preparing a mixture including 100 phr of a polyvinyl chloride resin, 5 phr to 20 phr of a plasticizer, 4 phr to 15 phr of a composite heat stabilizer, 0.5 phr to 3 phr of an accelerant, 1 phr to 5 phr of a toughener, 0.1 phr to 0.5 phr of a composite lubricant, 0.1 phr to 1 phr of an antioxidant, and 0.1 phr to 20 phr of a composite pigment; heating the mixture at a temperature ranging from 80° C. to 120° C. so as to form a dry powder; cooling the dry powder to a temperature ranging from 35° C. to 50° C. under a stirring state so as to form a resin composition. The composite heat stabilizer includes a calcium-zinc stabilizer and an auxiliary stabilizer. The accelerant is a copolymer polymerized from a vinyl chloride monomer and a polyester monomer. The composite pigment includes a core layer and a shell layer encapsulating the core layer.

In order to solve the above-mentioned problems, further another one of the technical aspects adopted by the present disclosure is to provide a plastic floor tile structure. The plastic floor tile structure includes a base layer, a middle layer, and a surface layer. The middle layer is formed from the resin composition mentioned above. The middle layer is disposed between the base layer and the surface layer.

Therefore, in the resin composition and the method for manufacturing the same, and the plastic floor tile structure, by virtue of “the composite heat stabilizer including a calcium-zinc stabilizer and an auxiliary stabilizer” and “the accelerant being a copolymer polymerized from a vinyl chloride monomer and a polyester monomer,” the resin composition can have a fast plasticization rate, thereby enhancing the printability of the middle layer.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic side view of a plastic floor tile structure of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

In order to enable the plastic floor tile to meet the requirement of environmental protection and safety, components in the resin composition of the present disclosure are improved by containing a calcium-zinc stabilizer, so as to achieve properties that are similar to those of with the conventional plastic floor tile.

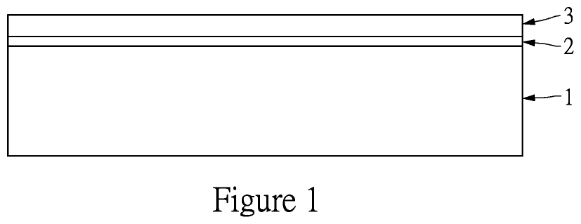

Referring to FIG. 1, a plastic floor tile structure of the present disclosure includes a base layer 1, a middle layer 2, and a surface layer 3. The middle layer 2 is disposed between the base layer 1 and the surface layer 3.

A material of the base layer 1 is polyvinyl chloride. In an exemplary embodiment, calcium carbonate particles are blended with a recycled polyvinyl chloride crushed aggregate to be used as the material of the base layer 1. A thickness of the base layer 1 can range from 0.2 mm to 0.5 mm.

The middle layer 2 of the present disclosure is formed from a resin composition. The resin composition includes 100 parts per hundred rubber (phr) of a polyvinyl chloride resin, 0.1 phr to 5 phr of a plasticizer, 4 phr to 15 phr of a composite heat stabilizer, 0.5 phr to 3 phr of an accelerant, 1 phr to 5 phr of a toughener, 0.1 phr to 0.5 phr of a composite lubricant, 0.1 phr to 1 phr of an antioxidant, and 0.1 phr to 20 phr of a pigment. A thickness of the middle layer 2 can range from 0.05 mm to 0.15 mm.

A material of the surface layer 3 is polyvinyl chloride. Specifically, the surface layer 3 can be a semi-rigid transparent polyvinyl chloride tape coated with a hardened treatment layer. A thickness of the surface layer 3 can range from 2 mm to 7 mm.

### Polyvinyl Chloride Resin

The polyvinyl chloride resin of the present disclosure has a degree of polymerization (DP) ranging from 700 to 1000. Specifically, the polyvinyl chloride resin can be formed by bulk polymerization (mass polymerization) or suspension polymerization. Alternatively, the polyvinyl chloride resin can include the polyvinyl chloride resin formed by bulk polymerization and the polyvinyl chloride resin formed by suspension polymerization.

When the degree of polymerization of the polyvinyl chloride resin is higher than 1000, the middle layer 2 formed from the polyvinyl chloride resin is difficult to manufacture. Whereas, when the degree of polymerization of the polyvinyl chloride resin is lower than 700, the middle layer 2 formed from the polyvinyl chloride resin may have insufficient mechanical strength. Therefore, in order to uphold both productivity and mechanical strength, the degree of polymerization of the polyvinyl chloride resin can preferably range from 750 to 900, and more preferably range from 750 to 850.

### Plasticizer

Since the polyvinyl chloride is a rigid plastic, the plasticizer can be added for reshaping purposes. The polyvinyl chloride resin can be softened or plasticized by the plasticizer, such that the polyvinyl chloride resin can have plasticity and can be compatible with other components.

In order to prevent the problems of emergence of molecular plastic and the formation of white stripes after a long period of use, an amount of the plasticizer is reduced in the present disclosure. The accelerant is added to facilitate the polyvinyl chloride resin being soften or plasticized. The specific descriptions regarding the accelerant will be provided later on in the disclosure.

The plasticizer can be selected from the group consisting of 1,2-cyclohexane dicarboxylic acid, di-isononyl ester (DHIN), dioctyl terephthalate (DOTP), triisoctyl trimellitate (TOTM), and cyclohexanedicarboxylic acid diisononyl ester (DIHCN).

### Composite Heat Stabilizer

In order to overcome the problem of the tin stabilizers and the zinc stabilizers containing phenolics such as bisphenol A, renohol, or phenol which are not environmental friendly and have safety concerns, phenolics are excluded from the composite heat stabilizer of the present disclosure.

The composite heat stabilizer of the present disclosure includes a calcium-zinc stabilizer and an auxiliary stabilizer. The calcium-zinc stabilizer can be a liquid calcium-zinc stabilizer or a powdered calcium-zinc stabilizer. Preferably, the liquid calcium-zinc stabilizer and the powdered calcium-zinc stabilizer are simultaneously added into the resin composition to further improve the appearance of the middle layer 2.

In order to overcome the problem of incomplete plasticization of the resin composition caused by the calcium-zinc stabilizer, the amount of the calcium-zinc stabilizer is decreased. In order to recover from the deficiency of the calcium-zinc stabilizer, the auxiliary stabilizer is added to enhance the heat resistance of the resin composition. Accordingly, the addition of the composite heat stabilizer can solve the problem caused by only adding the calcium-zinc stabilizer.

The auxiliary stabilizer can be selected from the group consisting of epoxidized soybean oil, dibenzoylmethane (DBM), and stearoylbenzoylmethane (SBM). In an exemplary embodiment, the auxiliary stabilizer includes epoxidized soybean oil and dibenzoylmethane.

Relative to 100 phr of the polyvinyl chloride resin, the amount of the calcium-zinc stabilizer can range from 3 phr to 10 phr. The amount of the calcium-zinc stabilizer is lower than the amount of the calcium-zinc stabilizer in the conventional resin composition. For example, the amount of the calcium-zinc stabilizer can be 4 phr, 5 phr, 6 phr, 7 phr, 8 phr, or 9 phr. Relative to 100 phr of the polyvinyl chloride resin, the amount of the auxiliary stabilizer can range from 1 phr to 5 phr. For example, the amount of the auxiliary stabilizer can be 2 phr, 3 phr, or 4 phr.

### Accelerant

As mentioned above, the decrease of the plasticizer and the usage of the calcium-zinc stabilizer reduce the plasticization rate. Therefore, the accelerant is added to facilitate the plasticization process.

The accelerant is a polymer having a high molecular weight which can increase a friction in a component system of the resin composition. During a mixing process, the high friction enables the resin composition to have a high heating rate, thereby enhancing the plasticization rate. In addition, the addition of the accelerant can enhance the printability of the middle layer 2 so as to compensate for the reduced printability caused by the usage of calcium-zinc stabilizer.

Specifically, the accelerant is a copolymer polymerized from a vinyl chloride monomer and a polyester monomer. Based on a total of the vinyl chloride monomer and the polyester monomer being 100 wt %, the amount of the vinyl chloride monomer ranges from 65 wt % to 85 wt %.

In an exemplary embodiment, the accelerant is modified by a functional group. The functional group can facilitate the plasticization of the polyvinyl chloride resin and help form a uniform resin composition. The addition of the accelerant can effectively improve the problem of the precipitation of the polyvinyl chloride resin at a die opening. The accelerant has properties of lubrication and impact resistance, such that the amounts of the external lubricant and an impact resistance modified agent can be decreased. The functional group can include at least one of a vinyl group, a vinylidene chloride group, a vinyl acetate group, a vinyl neodecanoate group, and an acrylate group.

When the functional group is a vinyl group or a vinylidene chloride group, a weight ratio of the functional group of the accelerant can range from 10 wt % to 15 wt %. When the functional group is a vinyl acetate group, a vinyl neodecanoate group, or an acrylate group, a weight ratio of the functional group of the accelerant can range from 5 wt % to 15 wt %.

In an exemplary embodiment, the accelerant is modified by at least one of the vinyl group and the vinylidene chloride group, and is further modified by at least one of the vinyl acetate group, the vinyl neodecanoate group, and the acrylate group.

For example, the accelerant can be modified by the vinylidene chloride group and the vinyl neodecanoate group. The weight ratio of the vinylidene chloride group of the accelerant ranges from 10 wt % to 15 wt %, and the weight ratio of the vinyl neodecanoate group of the accelerant ranges from 5 wt % to 15 wt %. Alternatively, the accelerant can be modified by the vinylidene chloride group and the acrylate group. The weight ratio of the vinylidene chloride group of the accelerant ranges from 10 wt % to 15 wt %, and the weight ratio of the acrylate group of the accelerant ranges from 5 wt % to 15 wt %.

Based on a total weight of the polyvinyl chloride resin being 100 phr, the amount of the accelerant can be 1 phr, 1.5 phr, 2phr, or 2.5 phr.

### Toughener

The addition of the toughener can enhance the mechanical strength of the middle layer 2, so as to reduce the abnormality in subsequent processing steps and improve the durability of the plastic floor tile structure.

Specifically, the toughener can be an acrylate elastomer (ACR), a methyl methacrylate-butadiene-styrene elastomer (MBS), or a chlorinated polyethylene elastomer (CPE), but the present disclosure is not limited thereto.

### Composite Lubricant

The composite lubricant includes an internal lubricant and an external lubricant.

The addition of the internal lubricant can promote the plasticization of the polyvinyl chloride resin and decrease the friction between polyvinyl chloride molecules. Therefore, the processing torque of the resin composition can be reduced, and the thermal stability of the resin composition can be enhanced.

It should be noted that the accelerant and the internal lubricant can both promote the plasticization of the polyvinyl chloride resin. Besides the promotion of the plasticization, the accelerant increases the friction between polyvinyl chloride molecules, while the internal lubricant decreases the friction between polyvinyl chloride molecules. Therefore, the accelerant and the internal lubricant are simultaneously added into the resin composition of the present disclosure, such that the plasticization of the polyvinyl chloride resin can be double promoted without changing the friction between polyvinyl chloride molecules.

The addition of the external lubricant can decrease the friction between the plastic pellets and equipment, thereby improving the productivity of the resin composition. However, when the external lubricant is excessively added, the printability of the middle layer will be decreased. It has been found through experiments that the addition of the accelerant can improve the printability of the middle layer. Therefore, even if the external lubricant is added into the resin composition, the middle layer of the present disclosure can still have good printability.

In an exemplary embodiment, a weight ratio of the internal lubricant to the external lubricant ranges from 3:7 to 7:3. Specifically, the internal lubricant is selected from the group consisting of a fatty alcohol, a fatty acid ester, and a fatty acid amide. The external lubricant is selected from the group consisting of a carboxylic acid ester wax, a polyethylene wax, and an oxidized polyethylene (OPE) wax.

### Antioxidant

The addition of the antioxidant can prevent the middle layer from yellowing after a long period of use which affects the appearance of the product. The antioxidant can be a hindered phenol antioxidant, a phosphite antioxidant, or a combination thereof.

For example, the hindered phenol antioxidant can be antioxidant with a model of Irganox® 1010 or Irganox® 1076. The phosphite antioxidant can be pentaerythritol bisphosphite, tris(2,4-di-tert-butylphenyl)phosphite, or a combination thereof, such as the antioxidant with a model of Irganox® 168.

### Composite Pigment

The color of the plastic floor tile structure is determined by the addition of the composite pigment. White pigment can be used for printing convenience, such as calcium carbonate, titanium dioxide, aluminum oxide, silicon dioxide, or a combination thereof.

Specifically, the composite pigment has a core layer and a shell layer encapsulating the core layer. For example, the shell layer can be anatase titanium dioxide or rutile titanium dioxide, in which the rutile titanium dioxide has a better weather resistance. The shell layer can be surface modified, such as being surface modified with aluminum oxide or silicon dioxide.

The core layer can be calcium carbonate. In other words, the composite pigment can be calcium carbonate encapsulated by titanium dioxide. In an exemplary embodiment, a size of the composite pigment can range from 1 μm to 5 μm. A specific gravity of the composite pigment can range from 2.6 to 3.5.

It should be noted that a size of the conventional titanium dioxide pigment is approximately 200 nm. Due to high material cost of titanium dioxide, it is less economical to use large-sized titanium dioxide as a pigment. Therefore, by using the composite pigment of the present disclosure, the resin composition can have good appearance with low material cost, thereby further enhancing the printability of the middle layer.

### Method for Manufacturing Resin Composition

The method for manufacturing the plastic floor tile structure of the present disclosure includes a preparing step (Step S1), a high-temperature mixing step (Step S2), and a low-temperature mixing step (Step S3).

In step S1, 100 phr of the polyvinyl chloride resin, 0.1 phr to 5 phr of the plasticizer, 4 phr to 15 phr of the composite heat stabilizer, 0.5 phr to 3 phr of the accelerant, 1 phr to 5 phr of the toughener, 0.1 phr to 0.5 phr of the composite lubricant, 0.1 phr to 1 phr of the antioxidant, and 0.1 phr to 20 phr of the pigment are weighed and mixed to form a mixture.

In step S2, the mixture is put into a mixer, and then stirred at high speed and at a temperature ranging from 80° C. to 120° C., so as to form a dry powder. A structure of the dry powder is loose. Subsequently, the dry powder is discharged into a cold mixing barrel.

In step S3, the dry powder is cooled to a temperature ranging from 35° C. to 50° C. under a stirring state so as to form a resin composition.

### Plastic Floor Tile Structure

In order to manufacture the plastic floor tile structure, the resin composition obtained by step S1 to step S3 is processed through a banbury mixer, a rolling mill, a filter extruder, and a tape machine at a temperature of 170° C. to 210° C., so as to form the middle layer 2.

Subsequently, the middle layer 2 is disposed between the base layer 1 and the surface layer 3 to form a laminate structure. The laminate structure is laminated to form manufacture a plastic floor tile structure. Specifically, the middle layer 2 is fixed between the base layer 1 and the surface layer 3 through thermal bonding. In other words, an adhesive can be absent from the plastic floor tile structure of the present disclosure. Since the main components of the base layer 1, the middle layer 2 and the surface layer 3 are all polyvinyl chloride, they have good bonding effects with each other.

### Experiment Data

In order to prove that the middle layer of the present disclosure has good properties and can be applied to plastic floor tile structure, the middle layer in Examples 1 to 4 and Comparative Examples 1 and 2 are manufactured according to step S1 to step S3 mentioned above. The specific components of the middle layer are listed in Table 1

In Table 1, the pigment is a composite pigment which has a core layer of calcium carbonate and a shell layer of titanium dioxide. The accelerant is purchased from LAURA & HANNELORE CO., LTD of the model VTER.

A tensile strength, a tear strength, a plasticization rate, and a balanced torsional strength of the middle layer are measured. In addition, an appearance, a hue, and printability of the middle layer are evaluated. The results are listed in Table 2.

In Table 2, the tensile strength of the middle layer is measured by a universal testing machine according to the ASTM D638 standard. The tear strength of the middle layer is measured by a universal testing machine according to the ASTM D1004 standard. The plasticization rate and the balanced torsional strength of the middle layer are measured by a torque rheometer at a temperature of 180° C. When the plasticization rate is less than 20 seconds, it is regarded as meeting the requirement.

In Table 2, the appearance of the middle layer is evaluated according to a surface of the middle layer. When the surface of the middle layer is free of coarse grains and flow marks, the middle layer is evaluated to have “good” appearance. When the surface of the middle layer is free of coarse grains but has flow marks, the middle layer is evaluated to have “fair” appearance. When the surface of the middle layer has coarse grains but has flow marks, the middle layer is evaluated to have “poor” appearance.

In Table 2, the heat resistance of the resin composition is evaluated according to a hue of the middle layer. The resin composition is processed by a rolling miller at a temperature of 190° C. for 40 minutes, and a delta E value before and after being processed is evaluated. When the delta E value of the middle layer is lower than 5, the resin composition is determined to have “good” heat resistance. When the delta E value of the middle layer ranges from 5 to 8, the resin composition is determined to have “fair” heat resistance. When the delta E value of the middle layer is higher than 8, the resin composition is determined to have “poor” heat resistance.

In Table 2, the printability of the middle layer is evaluated by attaching a 3M tape (model: 610) onto a printing layer of the middle layer and then quickly removing the 3M tape from the printing layer. When the printing layer is remained completeness after removing the 3M tape, the middle layer has “good” printability. When only a small portion of the printing layer falls off after removing the 3M tape, the middle layer has “fair” printability.

TABLE 1

| | Example | | | | Comparative Example | |
|---|---|---|---|---|---|---|
| (phr) | 1 | 2 | 3 | 4 | 1 | 2 |
| Polyvinyl | 100 | 100 | 100 | 100 | 100 | 100 |
| chloride | | | | | | |
| Plasticizer | DHIN | DHIN | DOTP | DOTP | DOTP | DOTP |
| | 2 | 2 | 2 | 2 | 2 | 2 |
| Powdered | 3 | 0 | 3 | 0 | 3 | 0 |
| calcium-zinc | | | | | | |
| stabilizer | | | | | | |
| Liquid | 2 | 5 | 2 | 5 | 2 | 5 |
| calcium-zinc | | | | | | |
| stabilizer | | | | | | |
| Auxiliary | DBM | DBM | DBM | DBM | DBM | DBM |
| stabilizer 1 | 0.3 | 0.3 | 0.3 | 0.3 | 0.3 | 0.3 |
| Auxiliary | Epoxidized | Epoxidized | Epoxidized | Epoxidized | Epoxidized | Epoxidized |
| stabilizer 2 | soybean oil | soybean oil | soybean oil | soybean oil | soybean oil | soybean oil |
| | 4 | 4 | 4 | 4 | 4 | 4 |
| Accelerant | Vinyl chloride polyester | | Vinyl chloride polyester | | Acrylate compound | |
| | copolymer modified by | | copolymer modified by | | | |
| | vinylidene chloride and | | vinylidene chloride and | | | |
| | vinyl neodecanoate group | | acrylate group | | | |
| | 2 | 2 | 2 | 2 | 2 | 2 |
| Toughener | MBS | ACR | MBS | MBS | MBS | MBS |
| | 3 | 3 | 3 | 3 | 5 | 5 |
| Composite | Oleamide+ | Oleamide+ | Oleamide+ | Oleamide+ | Oleamide+ | Butyl |
| lubricant | OPE wax | OPE wax | OPE wax | OPE wax | OPE wax | stearate+ |
| | | | | | | OPE wax |
| | 0.1 | 0.1 | 0.1 | 0.1 | 0.3 | 0.3 |
| Antioxidant | Irganox ® | Irganox ® | Irganox ® | Irganox ® | Irganox ® | Irganox ® |
| | 1010 | 1010 | 1010 | 1010 | 1010 | 1010 |
| | 0.2 | 0.2 | 0.2 | 0.2 | 0.2 | 0.2 |
| Pigment 1 | Titanium | Titanium | Titanium | Titanium | Titanium | Titanium |
| | dioxide | dioxide | dioxide | dioxide | dioxide | dioxide |
| | 15 | 15 | 15 | 15 | 15 | 15 |
| Pigment 2 | Ultramarine | Ultramarine | Ultramarine | Ultramarine | Ultramarine | Ultramarine |
| | 0.0005 | 0.0005 | 0.0005 | 0.0005 | 0.0005 | 0.0005 |

TABLE 2

| | | | | | Comparative | Comparative |
|---|---|---|---|---|---|---|
| | Example 1 | Example 2 | Example 3 | Example 4 | Example 1 | Example 2 |
| Tensile strength | 521.2 | 498.5 | 513.9 | 486.2 | 516.6 | 493.6 |
| (kg/cm²) | | | | | | |
| Tear strength | 30.2 | 29.1 | 29.8 | 27.9 | 29.7 | 28.4 |
| (kg/mm) | | | | | | |
| Plasticization rate | 18 | 17 | 19 | 17 | 26 | 19 |
| (second) | | | | | | |
| Balanced torsional | 8.72 | 8.47 | 8.63 | 8.39 | 9.23 | 8.66 |
| strength (N · m) | | | | | | |
| Appearance | Good | Fair | Good | Fair | Fair | Poor |
| Hue | Good | Good | Good | Good | Poor | Fair |
| Printability | Good | Good | Good | Good | Fair | Fair |

According to results of Table 1 and Table 2, the middle layer formed from the resin composition of the present disclosure has the tensile strength ranging from 480 kg/cm² to 540 kg/cm², the tearing strength ranging from 25 kg/mm to 32 kg/mm, and the balanced torsional strength ranging from 7 N·m to 12 N·m. In other words, the middle layer has appropriate mechanical strength for manufacturing the plastic floor tile structure.

In addition, by adjusting the components to use the environmental friendly heat stabilizer absent from phenolics (calcium-zinc stabilizer), the resin composition can still have a fast plasticization rate. Therefore, the problem of poor printability of the middle layer caused by the incomplete plasticization of the resin composition can be prevented.

### Beneficial Effects of the Embodiment

In conclusion, in the resin composition and the method for manufacturing the same, and the plastic floor tile structure, by virtue of “the composite heat stabilizer including a calcium-zinc stabilizer and an auxiliary stabilizer” and “the accelerant being a copolymer polymerized from a vinyl chloride monomer and a polyester monomer,” the resin composition can have a fast plasticization rate, thereby enhancing the printability of the middle layer.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A resin composition used to form a middle layer of a plastic floor tile structure, the resin composition comprising:
100 phr of a polyvinyl chloride resin;
0.1 phr to 5 phr of a plasticizer;
4 phr to 15 phr of a composite heat stabilizer, wherein the composite heat stabilizer includes a calcium-zinc stabilizer and an auxiliary stabilizer;
0.5 phr to 3 phr of an accelerant, wherein the accelerant is a copolymer polymerized from a vinyl chloride monomer and a polyester monomer;
1 phr to 5 phr of a toughener;
0.1 phr to 0.5 phr of a composite lubricant;
0.1 phr to 1 phr of an antioxidant; and
0.1 phr to 20 phr of a composite pigment, wherein the composite pigment has a core layer and a shell layer encapsulating the core layer.

2. The resin composition according to claim 1, wherein a size of the composite pigment ranges from 1 μm to 5 μm.

3. The resin composition according to claim 1, wherein the shell layer of the composite pigment is surface modified with aluminum oxide or silicon dioxide.

4. The resin composition according to claim 1, wherein the shell layer is titanium dioxide.

5. The resin composition according to claim 1, wherein a degree of polymerization of the polyvinyl chloride resin ranges from 700 to 1000.

6. The resin composition according to claim 1, wherein, relative to 100 phr of the polyvinyl chloride resin, an amount of the calcium-zinc stabilizer ranges from 3 phr to 10 phr, and the auxiliary stabilizer ranges from 1 phr to 5 phr.

7. The resin composition according to claim 1, wherein the auxiliary stabilizer is selected from the group consisting of epoxidized soybean oil, dibenzoylmethane, and stearoylbenzoylmethane.

8. The resin composition according to claim 1, wherein, based on a total weight of the vinyl chloride monomer and the polyester monomer to polymerize the accelerant being 100 wt %, an amount of the vinyl chloride monomer ranges from 65 wt % to 85 wt %.

9. The resin composition according to claim 1, wherein the accelerant is modified by a functional group selected from the group consisting of a vinyl group, a vinylidene chloride group, a vinyl acetate group, a vinyl neodecanoate group, and an acrylate group.

10. The resin composition according to claim 1, wherein the accelerant is modified by a vinylidene chloride group and an acrylate group.

11. The resin composition according to claim 1, wherein, based on a total weight of the accelerant being 100 wt %, the accelerant is modified by 10 wt % to 15 wt % of a vinyl group or a vinylidene chloride group.

12. The resin composition according to claim 1, wherein, based on a total weight of the accelerant being 100 wt %, the accelerant is modified by 5 wt % to 15 wt % of a vinyl acetate group, a vinyl neodecanoate group, or an acrylate group.

13. The resin composition according to claim 1, wherein the composite lubricant includes an internal lubricant and an external lubricant, and a weight ratio of the internal lubricant to the external lubricant ranges from 3:7 to 7:3.

14. The resin composition according to claim 1, wherein the internal lubricant is selected from the group consisting of a fatty alcohol, a fatty acid ester, and a fatty acid amide.

15. The resin composition according to claim 1, wherein the external lubricant is selected from the group consisting of a carboxylic acid ester wax, a polyethylene wax, and an oxidized polyethylene wax.

16. A method for manufacturing a resin composition, comprising:
preparing a mixture including 100 phr of a polyvinyl chloride resin, 0.1 phr to 5 phr of a plasticizer, 4 phr to 15 phr of a composite heat stabilizer, 0.5 phr to 3 phr of an accelerant, 1 phr to 5 phr of a toughener, 0.1 phr to 0.5 phr of a composite lubricant, 0.1 phr to 1 phr of an antioxidant, and 0.1 phr to 20 phr of a composite pigment; wherein the composite heat stabilizer includes a calcium-zinc stabilizer and an auxiliary stabilizer, the accelerant is a copolymer polymerized from a vinyl chloride monomer and a polyester monomer, and the composite pigment has a core layer and a shell layer encapsulating the core layer;
heating the mixture at a temperature ranging from 80° C. to 120° C. so as to form a dry powder; and
cooling the dry powder to a temperature ranging from 35° C. to 50° C. under a stirring state so as to form a resin composition.

17. A plastic floor tile structure, comprising:
a base layer;
a middle layer formed from the resin composition according to claim 1; and
a surface layer,
wherein the middle layer is disposed between the base layer and the surface layer.

18. The plastic floor tile structure according to claim 17, wherein a material of the base layer includes polyvinyl chloride, and a material of the surface layer includes polyvinyl chloride.
